(19) United States
(12) Patent Application Publication
(10) Pub. No.: US 2006/0291362 A1
(43) Pub. Date: Dec. 28, 2006

(54) Optical semiconductor device and method of manufacture thereof

(75) Inventors: Naoki Nakanishi, Shiga (JP); Shinichi Hamaguchi, Hyogo (JP); Hiroaki Yamamoto, Hyogo (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/406,473

(22) Filed: Apr. 18, 2006

(30) Foreign Application Priority Data
Jun. 23, 2005 (JP) JP2005-183820

(51) Int. Cl. G11B 7/135

(52) U.S. Cl. 369/112.1

(57) ABSTRACT

The present optical semiconductor device includes a semiconductor laser, an optical block provided with a hologram element for diffracting a laser beam that has been emitted from the semiconductor laser and reflected by a disk, a photo-detector for receiving the laser beam diffracted by the hologram element and outputting an electric signal, and a package for receiving the semiconductor laser and the photo-detector. An internal space of the package has a plurality of independent spaces, and the semiconductor laser and the photo-detector respectively are received in the spaces that are different from each other. With this configuration, it is possible to achieve an optical semiconductor device that can be made smaller and thinner and has a highly-reliable semiconductor laser element.

### BACKGROUND OF THE INVENTION

1. Field of the Invention The present invention relates to an optical semiconductor device capable of recording, reproducing and erasing an information signal with respect to an information medium such as an optical disk, and a method of manufacture thereof

2. Description of Related Art

In recent years, as represented by DVDs (Digital Versatile Disks), optical disks increasingly have been utilized in various fields such as audio equipment, video recorders and computers because of their capability of recording a large volume of information at high density. Furthermore, apparatuses for a larger-capacity and higher-density optical disk with respect to which information can be recorded and reproduced by a blue laser such as a BD (Blu-ray Disc) and a HD-DVD have begun to be developed and commercialized, and they are expected to become more and more widespread in the future. For installation in laptop personal computers and car audio equipment, a pickup device to be mounted on these optical disk apparatuses is strongly required to be smaller and thinner and have vibration-proof characteristics. In response to such a request, various integrated units and pickup devices have been suggested.

An optical pickup device having reduced size and thickness and improved vibration-proof characteristics is disclosed in, for example, JP 2001-102676 A. The configuration disclosed in this document provides an integrated unit in which a semiconductor laser and a photo-detector are integrated in a flat package, thereby reducing the number of components, making it possible to miniaturize the pickup.

In FIG. 16, a semiconductor laser 101 serving as a light source is mounted in a recessed portion 105 on a photo-detector substrate 103 formed of Si. In a lateral surface of the recessed portion 105, a Si (111) plane is formed as a 45°-inclined mirror 106 by etching.

A laser beam emitted from the semiconductor laser 101 is reflected by the 45°-inclined mirror 106 and travels upward perpendicularly to the photo-detector substrate 103. A reflected laser beam 202 passes through a hologram element 108 formed in an optical block 107, travels via optical systems such as a collimator lens and an objective lens (not shown) and enters an optical disk (not shown).

A reflected laser beam 201 from the optical disk is diffracted by the hologram element 108 and enters a photo-detector 104 on the photo-detector substrate 103, and an electric signal is generated in the photo-detector 104. The generated electric signal is subjected to voltage conversion, amplification and signal processing by an IV amplifier (not shown) formed on the photo-detector substrate 103, so that an information signal of the optical disk and a servo signal for adjusting an objective lens position are detected. The photo-detector substrate 103 in which the semiconductor laser 101 is integrated is mounted in a flat package 102.

In the configuration described above, the semiconductor laser, the photo-detector and the IV amplifier for signal processing are integrated, so as to achieve a smaller and thinner pickup device resulting from the reduction of the number of components and improve vibration-proof characteristics owing to the integration.

### SUMMARY OF THE INVENTION

However, the above-described configuration has the following two problems.
(1) Since the semiconductor laser 101 is mounted in the recessed portion 105 on the photo-detector substrate 103, the heat generated in the photo-detector substrate 103 has an adverse effect directly on the characteristics of the semiconductor laser 101.

More specifically, the photo-detector 104 and the IV amplifier are disposed on the photo-detector substrate 103, and Joule heat is generated when they are driven. This Joule heat raises a chip temperature of the semiconductor laser 101, thus deteriorating characteristics, for example, reducing an optical output and increasing an operating current. In order to suppress the influence of heat, there are a method of increasing the volumetric capacity of the recessed portion 105 in which the semiconductor laser 101 is mounted and a method of arranging the photo-detector 104 and the IV amplifier as far as possible from the semiconductor laser 101. However, both of these methods considerably increase the area of the photo-detector substrate 103, thus causing a cost increase.
(2) Since the semiconductor laser 101 is not sealed and is integrated with the photo-detector substrate 103, an organic gas in the air and an organic gas generated from hydrocarbons and other organic substances adhering to the photo-detector substrate 103 adhere to the surface of the semiconductor laser 101, thus deteriorating characteristics.

Substances contaminating the photo-detector substrate 103 are deposited or are generated when the photo-detector substrate 103 is stored in the air. Also, such substances may be sediments of Si dust from chipping or remaining pressure-sensitive adhesive sheet for holding diced chips per wafer during a manufacturing process.

It is an object of the present invention to provide an optical semiconductor device that can be made smaller and thinner, has no characteristic deterioration and is highly reliable. It is a further object of the present invention to provide a manufacturing method suitable for such an optical semiconductor device.

In order to solve the problems described above, an optical semiconductor device with a first configuration according to the present invention includes a laser element, an optical block provided with a hologram element for diffracting a laser beam that has been emitted from the laser element and reflected by an information medium, a light-receiving portion for receiving the laser beam diffracted by the hologram element and outputting an electric signal, and a package for receiving the laser element and the light-receiving portion. An internal space of the package includes a plurality of independent spaces, and the laser element and the light-receiving portion respectively are received in the spaces that are different from each other.

Also, an optical semiconductor device with a second configuration according to the present invention includes a laser element, an optical block provided with a hologram element for diffracting a laser beam that has been emitted from the laser element and reflected by an information medium, a light-receiving portion for receiving the laser beam diffracted by the hologram element and outputting an electric signal, a package that is integrated with the optical block and includes a first space for receiving the laser element and a second space for receiving the light-receiving portion, and a space separation element that can separate the first space and the second space from each other and formed of a material capable of transmitting light. The first space and the second space are separated by the space separation element, and the second space and the outside are separated spatially by the optical block.

Further, an optical semiconductor device with a third configuration according to the present invention includes a laser element, an optical block provided with a hologram element for diffracting a laser beam that has been emitted from the laser element and reflected by an information medium, a light-receiving portion for receiving the laser beam diffracted by the hologram element and outputting an electric signal, and a package that is integrated with the optical block and has a first space for receiving the laser element and a second space for receiving the light-receiving portion. The optical block is disposed so as to separate the first space and the second space.

Moreover, an optical semiconductor device with a fourth configuration according to the present invention includes a laser element, a first reflector element disposed so as to reflect a laser beam emitted from the laser element toward a side of an information medium, an optical block provided with a hologram element for diffracting the laser beam reflected by the information medium, a light-receiving portion for receiving the laser beam diffracted by the hologram element and outputting an electric signal, and a package for receiving the laser element, the first reflector element and the light-receiving portion. An internal space of the package includes a plurality of spaces that are separated by the first reflector element, and the laser element and the light-receiving portion respectively are received in different spaces.

Also, an optical semiconductor device with a fifth configuration according to the present invention includes a laser element, an optical block including a second reflector element disposed so as to reflect a laser beam that has been emitted from the laser element and reflected by an information medium and a third reflector element disposed so as to reflect the laser beam reflected by the second reflector element, a light-receiving portion for receiving the laser beam reflected by the third reflector element and outputting an electric signal, and a package for receiving the laser element and the light-receiving portion. An internal space of the package includes a plurality of independent spaces, and the laser element and the light-receiving portion respectively are received in different spaces.

In addition, a method for manufacturing an optical semiconductor device according to the present invention is a method for manufacturing an optical semiconductor device including a laser element, an optical block provided with a hologram element for diffracting a laser beam that has been emitted from the laser element and reflected by an information medium, a light-receiving portion for receiving the laser beam diffracted by the hologram element and outputting an electric signal, and a package for receiving the laser element and the light-receiving portion, wherein an internal space of the package is sealed by integrating the package and the optical block, and a space separation element provided in the package forms a plurality of spaces. The method includes a first process of bonding the laser element to the package, a second process of disposing the space separation element so as to seal a space receiving the laser element, a third process of bonding the light-receiving portion to the package, and a fourth process of integrating the optical block with the package.

### BRIEF DESCRIPTION OF THE DRAWINGS

FIG. 1 is a perspective view showing a disk reproducing apparatus in which an optical semiconductor device according to Embodiment 1 is mounted.

FIG. 2A is a side view showing the optical semiconductor device.

FIG. 2B is a perspective view showing a package.

FIG. 3A is a sectional view showing another configuration of the optical semiconductor device according to Embodiment 1.

FIG. 3B is a perspective view showing a package.

FIG. 4 is a sectional view showing another configuration of the optical semiconductor device according to Embodiment 1.

FIG. 5A is a sectional view showing an optical semiconductor device according to Embodiment 2.

FIG. 5B is a perspective view showing a package.

FIG. 6 is a sectional view showing the optical semiconductor device in a first process in a method for manufacturing the optical semiconductor device.

FIG. 7 is a sectional view showing the optical semiconductor device in a second process.

FIG. 8 is a sectional view showing the optical semiconductor device in a third process.

FIG. 9 is a sectional view showing the optical semiconductor device in a fourth process.

FIG. 10 is a sectional view showing another configuration of the optical semiconductor device according to Embodiment 2.

FIG. 11 is a sectional view showing another configuration of the optical semiconductor device according to Embodiment 2.

FIG. 12 is a sectional view showing an optical semiconductor device according to Embodiment 3.

FIG. 13 is a sectional view showing another configuration of the optical semiconductor device according to Embodiment 3.

FIG. 14 is a sectional view showing another configuration of the optical semiconductor device according to Embodiment 3.

FIG. 15A is a sectional view showing an optical semiconductor device according to Embodiment 4.

FIG. 15B is a perspective view showing an optical block in the optical semiconductor device.

FIG. 16 is a perspective view showing a conventional optical semiconductor device.

### DETAILED DESCRIPTION OF THE INVENTION

The optical semiconductor device with the first configuration according to the present invention may include a space separation element for separating the internal space of the package into a first space for receiving the laser element and a second space for receiving the light-receiving portion.

Also, it is preferable that the package and the space separation element are molded integrally. This preferable configuration eliminates a process of making the package and the space separation element adhere to each other and thus is effective in shortening a production time and cutting costs. Further, since the use of the adhesive or the like necessary for the adhering process can be reduced, it becomes possible to suppress outgassing from the adhesive, thereby improving the reliability of the optical semiconductor device.

In the optical semiconductor device with the second configuration according to the present invention, it is preferable that the space separation element is formed of a light-transmitting material. With this preferable configuration, the space separation element can be disposed on an optical axis of light emitted from the semiconductor laser. This makes it possible to form a space for sealing the semiconductor laser only with the package and the space separation element, and the further integration of the package and the optical block achieves an even better airtightness of the sealing space in which the semiconductor laser is received. In this manner, the reliability of the optical semiconductor device can be improved.

Also, it is preferable that the space separation element includes a three-beam generating diffraction grating for branching the laser beam emitted from the semiconductor laser element into a main beam and two sub beams. With this preferable configuration, it is possible to deal with a “three-beam tracking system”, which is used widely as a general tracking servo system. Further, since the diffraction grating is formed on the space separation element, the size of the apparatus does not increase.

In the optical semiconductor device with the third configuration according to the present invention, it is preferable that the optical block includes a diffraction grating for splitting the laser beam emitted from the laser element into a plurality of laser beams.

In the optical semiconductor device with the fourth configuration according to the present invention, it is preferable that the package and the first reflector element are integrally molded. With this preferable configuration, the process of making the package and the first reflector element adhere to each other is eliminated, so that the production time can be shortened and the costs can be cut. Further, since the use of the adhesive or the like necessary for the adhering process can be reduced, it becomes possible to suppress outgassing from the adhesive, thereby improving the reliability of the optical semiconductor device further.

Further, it is preferable that the first reflector element includes a part reflecting the laser beam emitted from the laser element, and the part is coated with a metallic material or a dielectric material. With this preferable configuration, the reflectivity of the first reflector element can be improved, thus making it possible to utilize the amount of light emitted from the semiconductor laser without any loss. This allows the amount of light emitted from the semiconductor laser to be reduced, so that the reliability of the optical semiconductor device can be improved further.

Moreover, in the first to fifth configurations of the optical semiconductor device according to the present invention, it is preferable that the sealing space receiving the semiconductor laser element has a smaller volume than the sealing space receiving the photo-detector. With this preferable configuration, since the volume of the space receiving the semiconductor laser decreases, an organic gas in the air is reduced, so that the reliability of the optical semiconductor device can be improved further.

Also, it is preferable that an emission wavelength of the semiconductor laser element is 380 to 420 nm. With this preferable configuration, it becomes possible to respond to the specifications for a large-capacity and high-density optical disk such as a Blu-ray Disc or a HD-DVD.

As described above, according to the present invention, it is possible to prevent characteristic deterioration of the laser element caused by the heat and dust generated in the light-receiving portion. Thus, the reliability of the optical semiconductor device can be improved considerably.

Furthermore, since the laser element, the light-receiving portion, the hologram element and the package are integrated, it is possible to reduce the size and thickness and achieve better vibration-proof characteristics.

Moreover, both of a +first-order diffraction light beam and a −first-order diffraction light beam that are diffracted by the hologram element can be detected by the same photo-detector substrate. This increases the amount of received light, thus making it possible to improve a signal-to-noise ratio (in the following, referred to as an SN ratio).

In addition, with the method for manufacturing an optical semiconductor device according to the present invention, it is possible to suppress loss when a failure of an individual element occurs.

Embodiment 1

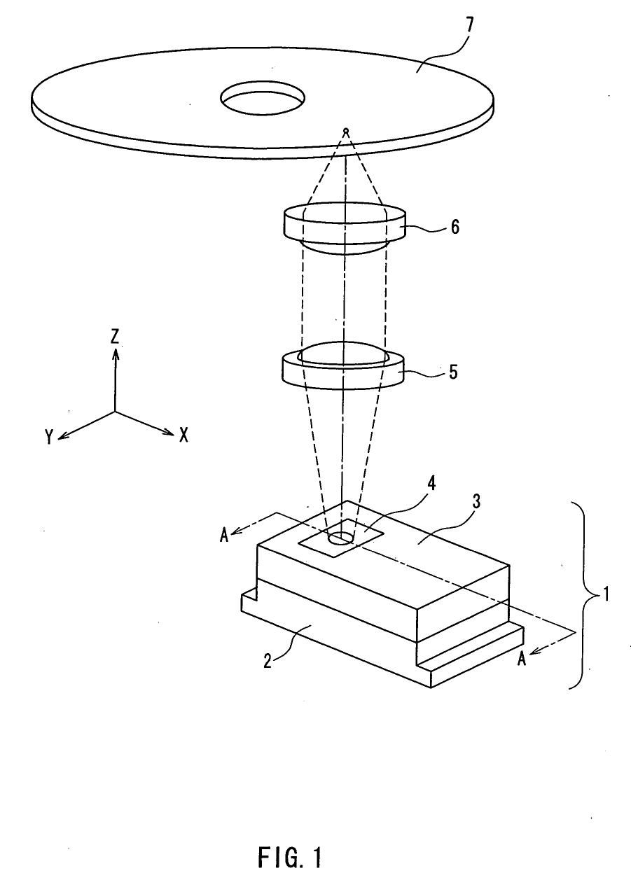

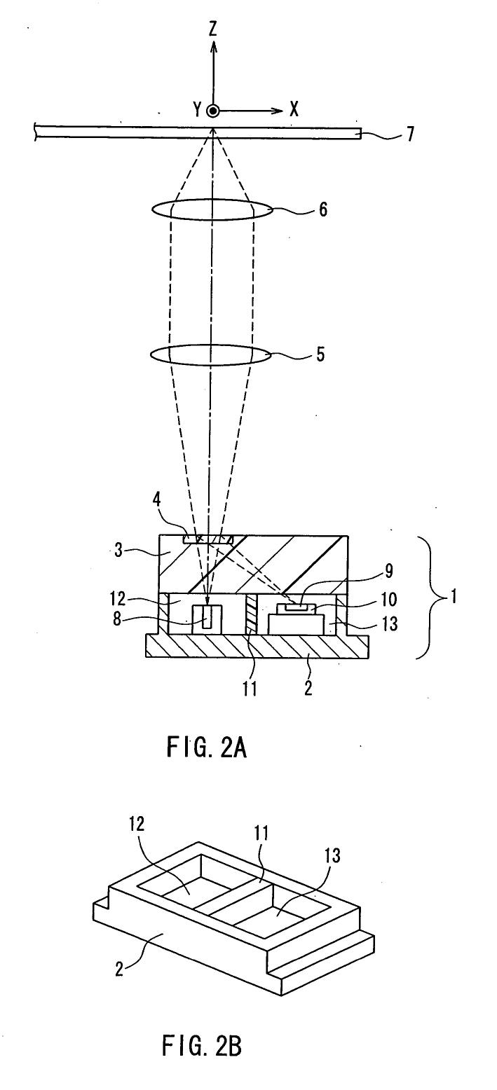

FIG. 1 is a perspective view showing a configuration of a disk reproducing apparatus in which an optical semiconductor device according to Embodiment 1 is mounted as an example. FIG. 2A is a side view showing the disk reproducing apparatus shown in FIG. 1, with only the optical semiconductor device being shown in cross-section taken along A-A in FIG. 1. FIG. 2B is a perspective view showing a package.

Referring to FIG. 1, in an optical semiconductor device 1, a package 2 having a semiconductor laser and a photo-detector, etc. therein and an optical block 3 provided with a hologram element 4 are integrated. A divergent light beam emitted from the semiconductor laser leaves the hologram element 4, is turned into a parallel light beam by a collimator lens 5 and focused on an information surface of an optical disk 7 by an objective lens 6.

The light beam reflected by the information surface of the disk 7 travels via the objective lens 6 and the collimator lens 5 and enters the optical semiconductor device 1. The incident light beam is received by the photo-detector disposed in the optical semiconductor device 1, converted to an electric signal and outputted.

Now, the operation of the optical semiconductor device 1 will be described.

As shown in FIG. 2A, a divergent light beam emitted from a semiconductor laser 8 passes through the optical block 3 and the hologram element 4, leaves the hologram element 4, is turned into a parallel light beam by the collimator lens 5 and then focused on the information surface of the optical disk 7 by the objective lens 6.

The light beam reflected by the information surface of the optical disk 7 passes through the objective lens 6 and the collimator lens 5 and then enters the hologram element 4 formed in the optical block 3. The hologram element 4 diffracts the incident reflected light beam toward a side of a photo-detector 9. The diffracted light beam enters the photo-detector 9 and is converted to an electric signal.

The photo-detector 9 is formed on a photo-detector substrate 10 made of Si or the like. The photo-detector 9 and the photo-detector substrate 10 constitute a light-receiving portion.

The electric signal outputted from the photo-detector 9 is subjected to signal processing such as voltage conversion and amplification by an IV amplifier (not shown) formed on the photo-detector substrate 10. Based on the electric signal subjected to the signal processings, information recorded in the optical disk and a servo signal for adjusting an objective lens position are detected.

Further, as shown in FIG. 2A and FIG. 2B, an internal space of the package 2 is separated into a first space 12 and a second space 13 by a space separation element 11. In other words, the space separation element 11 is provided so that physical communication between the semiconductor laser 8 and the photo-detector 9 is blocked, whereby the first space 12 and the second space 13 are formed. The semiconductor laser 8 is received in the first space 12, and the photo-detector substrate 10 on which the photo-detector 9 is mounted is received in the second space 13. Further, an end face of the space separation element 11 cooperates with the surface of the package 2.

The above-described package 2 is integrated with the optical block 3 by an adhesive or the like so that its opening is closed as shown in FIG. 2A, thereby sealing the first space 12 and the second space 13.

As described above, in accordance with the present embodiment, the semiconductor laser 8 and the photo-detector substrate 10 respectively are disposed in the first space 12 and the second space 13 that are separated spatially. Therefore, the heat generated in the photo-detector substrate 10 and the photo-detector 9 is not transmitted to the semiconductor laser 8. Consequently, it is possible to prevent characteristics of the semiconductor laser 8 from deteriorating due to an increase in a chip temperature.

Also, dust adhering to the photo-detector substrate 10 and an organic gas generated from organic substances such as hydrocarbons can be prevented from adhering to the semiconductor laser 8, thus avoiding the deterioration of characteristics of the semiconductor laser 8.

Moreover, since the semiconductor laser 8, the photo-detector 9, the hologram element 4 and the package 2 are integrated, the reduction of size and thickness and the improvement of vibration-proof characteristics of an optical pickup device can be achieved.

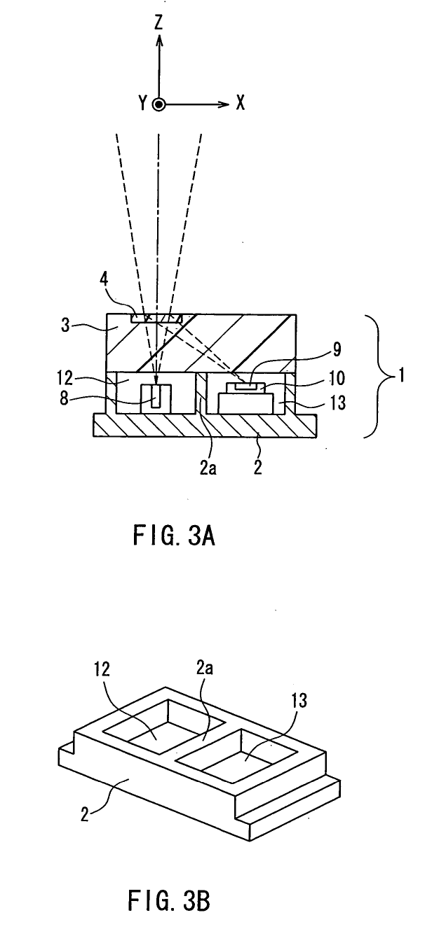

In the configuration illustrated in FIGS. 2A and 2B, the package 2 and the space separation element 11 are different members. However, as shown in FIGS. 3A and 3B, a space separation portion 2a for separating the internal space of the package 2 also may be provided in the package 2 by integral molding. In this case, an end face of the space separation portion 2a cooperates with the surface of the package 2. Incidentally, the method for integral molding can be, for example, a resin integral molding. This eliminates the need for a process of making the package 2 and the space separation element 11 adhere to each other, thus allowing a shorter production time and lower costs for the optical semiconductor device 1. Further, since it is possible to reduce the amount of the adhesive to be used, outgassing from the adhesive can be suppressed, thereby improving the reliability of the optical semiconductor device further.

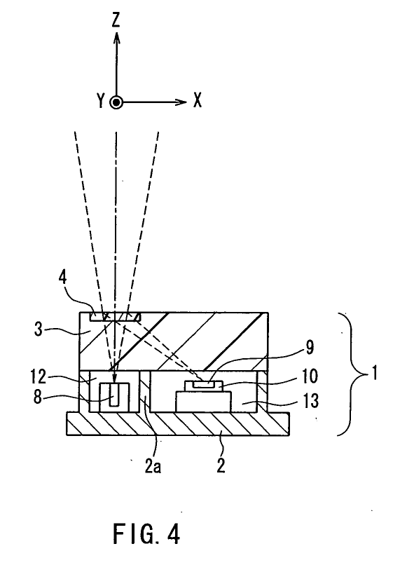

Also, as shown in FIG. 4, the first space 12 receiving the semiconductor laser 8 may have a smaller volumetric capacity than the second space 13 receiving the photo-detector substrate 10. This makes it possible to reduce an absolute amount of an organic gas in the first space 12 when the package 2 and the optical block 3 are integrated. Thus, the reliability of the optical semiconductor device 1 can be improved further.

Embodiment 2

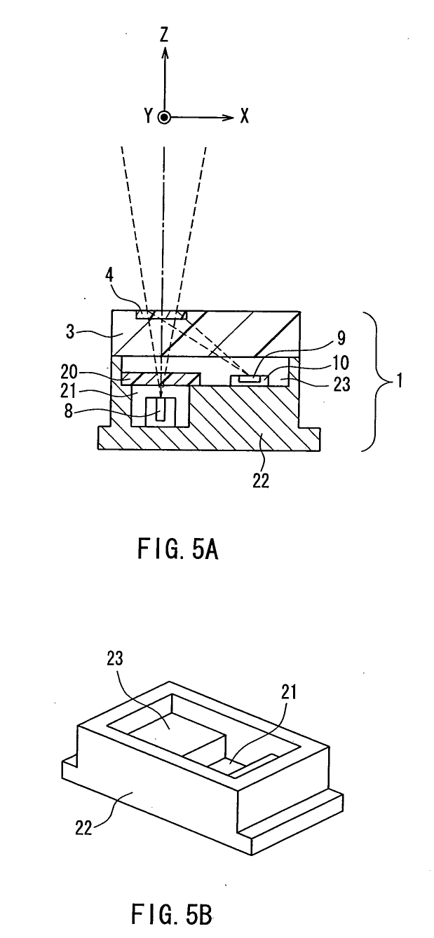

FIG. 5A is a sectional view showing a configuration of an optical semiconductor device according to Embodiment 2. FIG. 5B is a perspective view showing a package in the above-noted device. Incidentally, since optical systems other than an optical semiconductor device 1 have a configuration equivalent to that shown in FIG. 1, they are omitted from the figures.

First, the following description will be directed to the operation of a disk reproducing apparatus in which the optical semiconductor device according to Embodiment 2 is mounted.

In FIG. 5A, a divergent light beam emitted from a semiconductor laser 8 passes through a space separation element 20 formed of a light-transmitting material and a hologram element 4 that are arranged on an optical axis of an emitted light beam from the semiconductor laser, is turned into a parallel light beam by a collimator lens 5 (see FIG. 1) and then focused on an optical disk 7 (see FIG. 1) by an objective lens 6 (see FIG. 1).

Further, a light beam reflected from the optical disk 7 passes through the objective lens 6 and the collimator lens 5 and then enters the hologram element 4 formed in an optical block 3 as shown in FIG. 5A. The reflected light beam that has entered the hologram element 4 is diffracted toward a side of a photo-detector 9. The diffracted light beam enters the photo-detector 9 provided on a photo-detector substrate 10, is converted to an electric signal and then detected.

The following is a specific description of the configuration of the optical semiconductor device 1.

As shown in FIG. 5B, a package 22 has an internal space with its upper part open. The internal space of the package 22 is separated into a third space 21 in which the semiconductor laser 8 is disposed and a fourth space 23 in which the photo-detector substrate 10 is disposed by the space separation element 20 as shown in FIG. 5A. In other words, the space separation element 20 is provided so that physical communication between the semiconductor laser 8 and the photo-detector 9 is blocked, whereby the third space 21 and the fourth space 23 are formed.

The above-described package 22 is integrated with the optical block 3 by an adhesive or the like so that its opening is closed as shown in FIG. 5A, thereby sealing the third space 21 and the fourth space 23.

As described above, in accordance with the present embodiment, since the third space 21 receiving the semiconductor laser 8 is separated from the air by the fourth space 23 formed by integrating the package 22 and the optical block 3, its airtightness improves. In other words, since the fourth space 23 is present between the third space 21 and the outside, the airtightness of the third space 21 can be improved. In this way, the reliability of the semiconductor laser 8 can be improved further.

Now, a method for manufacturing the optical semiconductor device will be described.

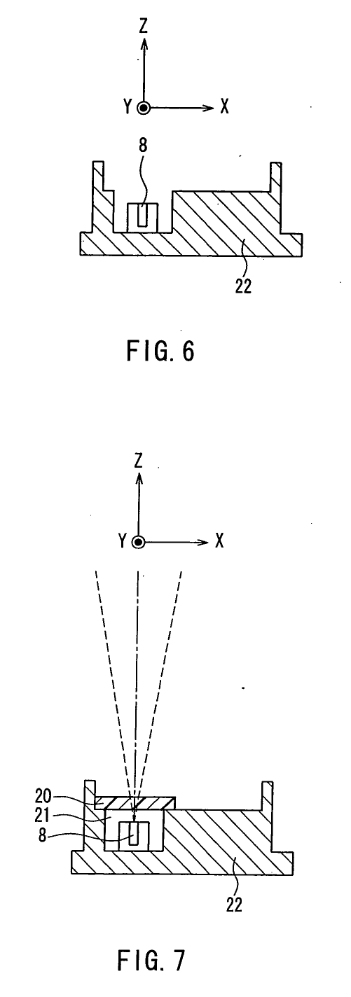

First, as shown in FIG. 6, the semiconductor laser 8 is bonded to and integrated with the package 22 (first process).

Next, as shown in FIG. 7, the space separation element 20 is made to adhere to and integrated with the package 22. At this time, the space separation element 20 is arranged so as to close the opening of the third space 21. In this manner, the third space 21 receiving the semiconductor laser 8 is formed (second process).

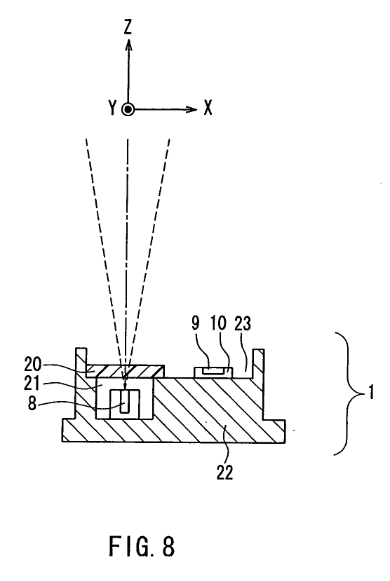

Then, as shown in FIG. 8, the photo-detector substrate 10 provided with the photo-detector 9 is bonded to and integrated with the package 22 (third process).

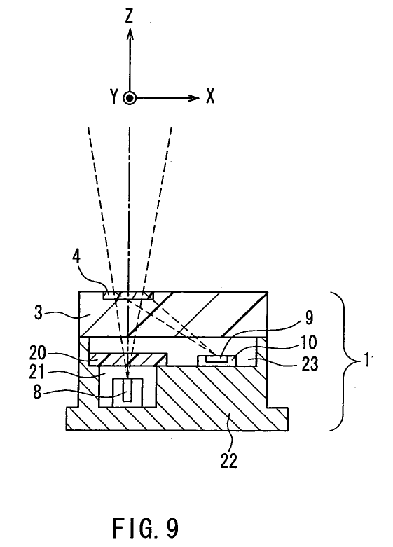

Subsequently, as shown in FIG. 9, the optical block 3 provided with the hologram element 4 is made to adhere to and integrated with the package 22. At this time, the optical block 3 is arranged at a position closing the opening of the package 22. In this manner, the fourth space 23 receiving the photo-detector substrate 10 is formed (fourth process).

As described above, the manufacturing method according to the present embodiment forms the third space 21 and the fourth space 23 not at the same time but step by step.

As described above, with the method for manufacturing an optical semiconductor device according to the present embodiment, it is possible to suppress the loss accompanying the discarding of optical semiconductor devices with poor characteristics at the time of production.

In other words, as shown in FIG. 7, when the formation of the third space 21 is completed (when the second process is completed), the semiconductor laser can be driven to inspect various characteristics such as electric current—optical output characteristics, electric current —voltage characteristics and beam far field characteristics. Accordingly, in the case where a semiconductor laser device having poor laser emission light characteristics or the like is found at the time of inspection in mass production, it is appropriate just to discard the semiconductor laser 8, the package 22 and the space separation element 20 that are integrated when the second process is completed. This makes it possible to suppress loss considerably compared with the case of discarding after the further integration of the photo-detector substrate 10 and the optical block 3.

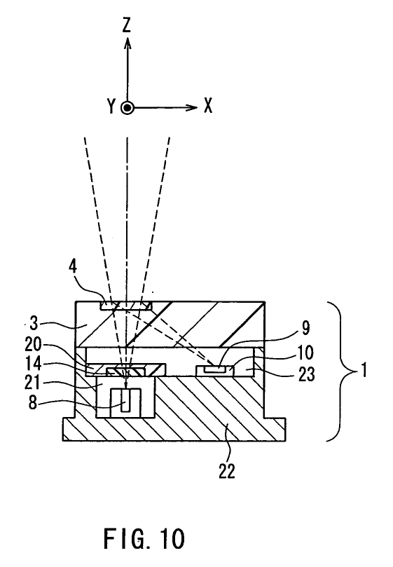

Incidentally, as shown in FIG. 10, the space separation element 20 also may be provided with a three-beam generating diffraction grating 14 for branching the light beam emitted from the semiconductor laser 8 into a main beam and two sub beams. With this structure, it is possible to deal with a “three-beam tracking system”, which is used widely as a general tracking servo system. Further, since the diffraction grating 14 can be formed on the space separation element 20 by surface processing or molding, the number of components or the size of the apparatus does not increase.

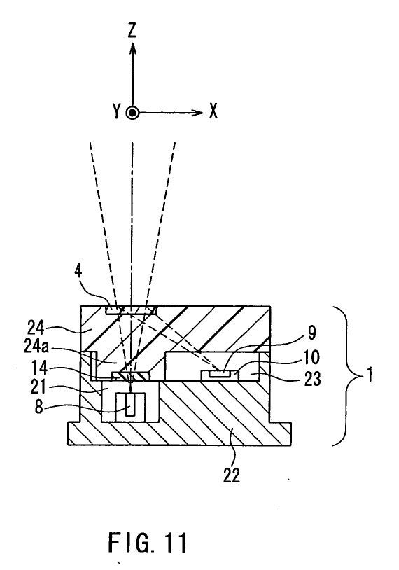

Alternatively, an optical block 24 having a structure as shown in FIG. 11 may be provided. In FIG. 11, the optical block 24 has a protruding portion 24a protruding downward. The protruding portion 24a closes the opening of the third space 21 with its end and spatially separates the third space 21 and the fourth space 23. Also, the optical block 24 shown in FIG. 11 is provided with the hologram element 4 and the diffraction grating 14. By integrating the above-noted optical block 24 and the package 22, the third space 21 and the fourth space 23 are formed. With this configuration, the hologram element 4 and the diffraction grating 14 are formed in the optical block 24, and the optical block 24 is integrated with the package 22, whereby the third space 21 and the fourth space 23 can be formed. This eliminates the need for any space separation element, thus making it possible to reduce the cost of the optical semiconductor device 1.

Embodiment 3

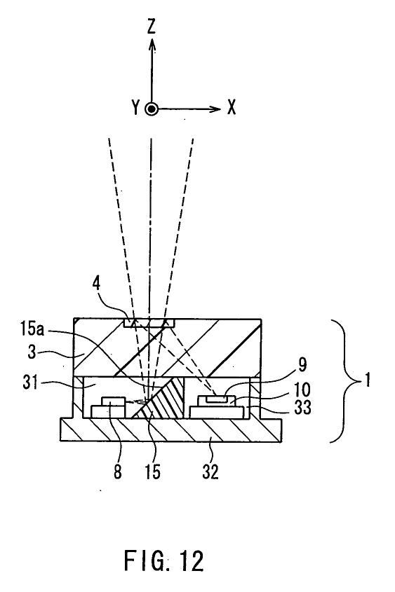

FIG. 12 is a sectional view showing a configuration of an optical semiconductor device according to Embodiment 3. Incidentally, since optical systems other than an optical semiconductor device 1 have a configuration equivalent to that shown in FIG. 1, they are omitted from the figures.

First, the following description will be directed to the operation of a disk reproducing apparatus in which the optical semiconductor device is mounted.

In FIG. 12, a divergent light beam emitted horizontally from a semiconductor laser 8 is reflected by a reflecting surface 15a of a first reflector element 15 that is inclined at 45° with respect to an optical axis of emitted light, whereby its optical path is changed by 90°. Thereafter, the light beam is turned into a parallel light beam by a collimator lens 5 (see FIG. 1) and then focused on an optical disk 7 (see FIG. 1) by an objective lens 6 (see FIG. 1).

A light beam reflected from the optical disk 7 travels via the objective lens 6 and the collimator lens 5, enters a hologram element 4 formed in an optical block 3 as shown in FIG. 12 and is diffracted toward a side of a photo-detector 9. The diffracted light beam enters the photo-detector 9, where a signal detection is carried out.

The following is a description of the configuration of the optical semiconductor device 1.

As shown in FIG. 12, the first reflector element 15 is disposed in a package 32. The first reflector element 15 includes the reflecting surface 15i a for reflecting a light beam emitted from the semiconductor laser 8. Also, the first reflector element 15 is fixed to the internal part of the package 32 with an adhesive or the like, thus separating the internal space of the package 32 so as to form a fifth space 31 and a sixth space 33. The semiconductor laser 8 is received in the fifth space 31, and a photo-detector substrate 10 including the photo-detector 9 is received in the sixth space 33. In other words, the first reflector element 15 is provided so that physical communication between the semiconductor laser 8 and the photo-detector 9 is blocked, whereby the fifth space 31 and the sixth space 33 are formed.

As described above, in accordance with the present embodiment, since the semiconductor laser 8 and the photo-detector substrate 10 respectively are received in the fifth space 31 and the sixth space 33 that are different sealing spaces, the semiconductor laser 8 is not affected by heat or organic substances generated from the photo-detector substrate 10, so that deterioration of its characteristics can be suppressed.

Furthermore, according to the present embodiment, the first reflector element 15 is disposed, thereby allowing the semiconductor laser 8 to be mounted such that the optical axis of its emitted light is in parallel with a bottom surface of the package 32. Accordingly, at the time of bonding by a general chip bonding technique (for example, a technique in which the semiconductor laser 8 and the photo-detector substrate 10 are vacuum-held with vacuum tweezers and bonded to the package 32), the direction in which the vacuum tweezers can be moved when bonding the semiconductor laser 8 and that in which the vacuum tweezers can be moved when bonding the photo-detector substrate 10 are the same (the direction indicated by an arrow Z in FIG. 12), so that the workability can be improved.

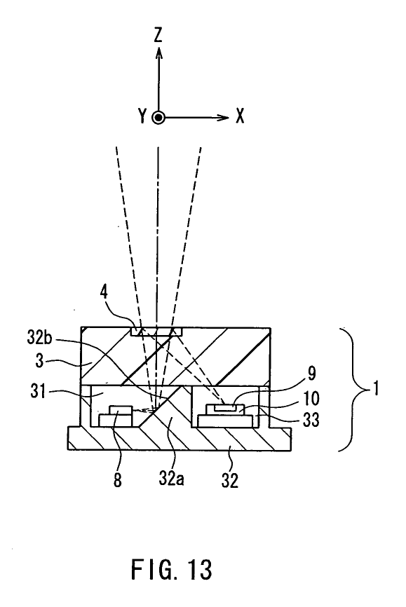

In the configuration illustrated in FIG. 12, the package 32 and the first reflector element 15 are formed as different members. However, they also may be formed by integral molding. In other words, as shown in FIG. 13, a reflector portion 32a is formed in the package 32 by integral molding, thereby eliminating the process of making the package 32 and the first reflector element 15 adhere to each other, so that the production time can be shortened and the costs can be cut. Further, since the use of the adhesive or the like necessary for the adhering process can be reduced, it becomes possible to suppress outgassing from the adhesive, thereby improving the reliability of the optical semiconductor device further. Incidentally, in FIG. 13, a reflecting surface 32b is formed on the reflector portion 32a by mirror finishing or the like.

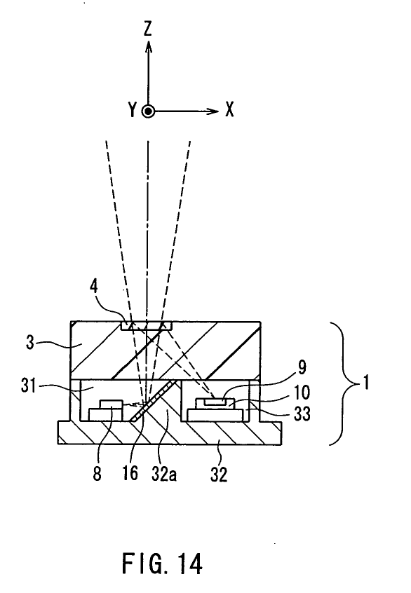

Moreover, as shown in FIG. 14, the reflector portion 32a also may be coated with a reflecting film 16. This reflecting film 16 may be formed of a deposited film of metal such as Al, Ag or Au or may be formed of a dielectric deposited film such a MgF₂ or TiO₂ film. Also, a multilayer film combining a metallic material and a dielectric material may be provided. With this structure, it becomes possible to improve the light reflectivity of the reflector portion 32a, so that the loss of the amount of light emitted from the semiconductor laser 8 can be reduced. This allows driving with a reduced amount of light emitted from the semiconductor laser 8, thereby reducing the power consumption. Consequently, the reliability of the optical semiconductor device can be improved further. It should be noted that a similar effect is obtained by providing the reflecting film 16 in the first reflector element 15 shown in FIG. 12.

Embodiment 4

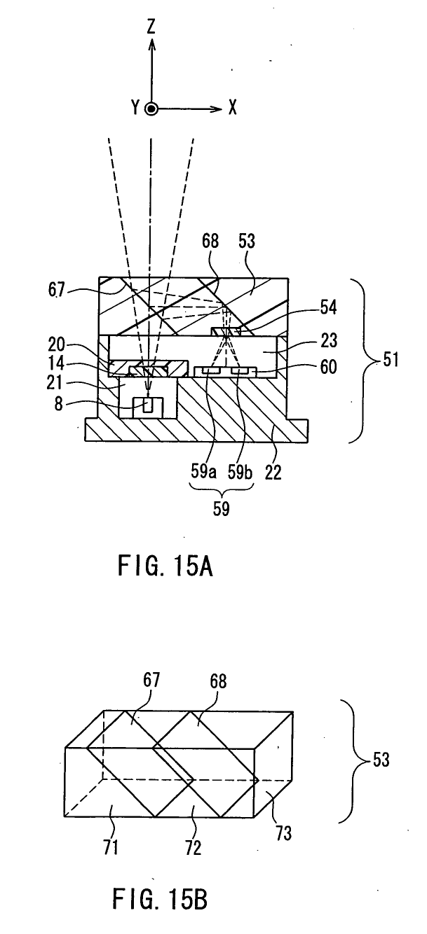

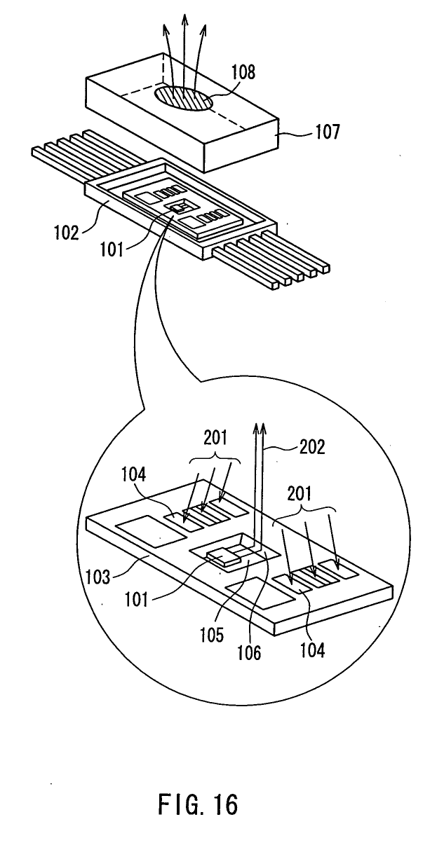

FIG. 15 is a sectional view showing an optical semiconductor device according to Embodiment 4. Incidentally, since optical systems other than an optical semiconductor device 1 have a configuration equivalent to that shown in FIG. 1, they are omitted from the figures.

First, the following description will be directed to the operation of a disk reproducing apparatus in which the optical semiconductor device is mounted.

In FIG. 15A, a divergent light beam emitted from a semiconductor laser 8 is branched into a main beam, a first sub beam and a second sub beam by a three-beam generating diffraction grating 14 formed on a space separation element 20. These three beams pass through a collimator lens 5 (see FIG. 1) and an objective lens 6 (see FIG. 1) and then are focused on an optical disk 7 (see FIG. 1).

The three beams reflected by an information surface of the optical disk 7 pass through the objective lens 6 and the collimator lens 5 and then are reflected by a second reflector element 67 formed in an optical block 53 as shown in FIG. 15A so that their optical paths are changed by 90°. The reflected light beams whose optical paths have been changed are reflected by a third reflector element 68 so that their optical paths are changed further by 90°, and branched into ±first-order diffraction light beams by a hologram element 54. The ±first-order diffraction light beams of each of the main beam, the first sub beam and the second sub beam enter photo-detectors 59a and 59b formed on a photo-detector substrate 60, are converted into an electric signal and detected.

As shown in FIG. 15B, the optical block 53 in the present embodiment is formed by attaching three optical glass members 71, 72 and 73 to each other, and a dielectric multilayer film or the like is deposited onto their attached portions so as to form the second reflector element 67 and the third reflector element 68.

As described above, in accordance with the present embodiment, it becomes possible to arrange the hologram element 54 right above the photo-detector substrate 60, so that both of the +first-order diffraction light beam and the −first-order diffraction light beam that are diffracted by the hologram element 54 can be detected by the same photo-detector substrate 60. This increases the amount of received light, thus making it possible to improve an SN ratio.

With the optical semiconductor device according to the present invention, the characteristics of the semiconductor laser do not deteriorate due to the heat and organic substances generated from the photo-detector substrate. Thus, the optical semiconductor device according to the present invention is useful for improving the reliability of an optical pickup device.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical semiconductor device comprising:
a laser element;
an optical block provided with a hologram element for diffracting a laser beam that has been emitted from the laser element and reflected by an information medium;
a light-receiving portion for receiving the laser beam diffracted by the hologram element and outputting an electric signal; and
a package for receiving the laser element and the light-receiving portion;
wherein an internal space of the package comprises a plurality of independent spaces, and
the laser element and the light-receiving portion respectively are received in the spaces that are different from each other.

2. The optical semiconductor device according to claim 1, further comprising a space separation element for separating the internal space of the package into a first space for receiving the laser element and a second space for receiving the light-receiving portion.

3. The optical semiconductor device according to claim 2, wherein the package and the space separation element are integrally molded.

4. An optical semiconductor device comprising:
a laser element;
an optical block provided with a hologram element for diffracting a laser beam that has been emitted from the laser element and reflected by an information medium;
a light-receiving portion for receiving the laser beam diffracted by the hologram element and outputting an electric signal;
a package that is integrated with the optical block and comprises a first space for receiving the laser element and a second space, provided at a position crossing an optical axis of the laser beam emitted from the laser element, for receiving the light-receiving portion; and
a space separation element, formed of a light-transmitting material, for separating the first space and the second space from each other;
wherein the first space and the second space are separated by the space separation element, and
the second space and an outside are separated spatially by the optical block.

5. The optical semiconductor device according to claim 4, wherein the space separation element comprises a diffraction grating for branching the laser beam emitted from the laser element into a main beam and two sub beams.

6. An optical semiconductor device comprising:
a laser element;
an optical block provided with a hologram element for diffracting a laser beam that has been emitted from the laser element and reflected by an information medium;
a light-receiving portion for receiving the laser beam diffracted by the hologram element and outputting an electric signal; and
a package that is integrated with the optical block and comprises a first space for receiving the laser element and a second space for receiving the light-receiving portion;
wherein the optical block is disposed so as to separate the first space and the second space.

7. The optical semiconductor device according to claim 6, wherein the optical block comprises a diffraction grating for splitting the laser beam emitted from the laser element into a plurality of laser beams.

8. An optical semiconductor device comprising:
a laser element;
a first reflector element disposed so as to reflect a laser beam emitted from the laser element toward a side of an information medium;
an optical block provided with a hologram element for diffracting the laser beam reflected by the information medium;
a light-receiving portion for receiving the laser beam diffracted by the hologram element and outputting an electric signal; and
a package for receiving the laser element, the first reflector element and the light-receiving portion;
wherein an internal space of the package comprises a plurality of spaces that are separated by the first reflector element, and
the laser element and the light-receiving portion respectively are received in the spaces that are different from each other.

9. The optical semiconductor device according to claim 8, wherein the package and the first reflector element are integrally molded.

10. The optical semiconductor device according to claim 8, wherein the first reflector element comprises a part reflecting the laser beam emitted from the laser element, the part being coated with a metallic material or a dielectric material.

11. The optical semiconductor device according to claim 9, wherein the first reflector element comprises a part reflecting the laser beam emitted from the laser element, the part being coated with a metallic material or a dielectric material.

12. An optical semiconductor device comprising:
a laser element;
an optical block comprising a second reflector element disposed so as to reflect a laser beam that has been emitted from the laser element and reflected by an information medium and a third reflector element disposed so as to reflect the laser beam reflected by the second reflector element;
a light-receiving portion for receiving the laser beam reflected by the third reflector element and outputting an electric signal; and
a package for receiving the laser element and the light-receiving portion;
wherein an internal space of the package comprises a plurality of independent spaces, and
the laser element and the light-receiving portion respectively are received in the spaces that are different from each other.

13. The optical semiconductor device according to any of claim 1, wherein the space receiving the laser element has a smaller volumetric capacity than the space receiving the light-receiving portion.

14. The optical semiconductor device according to any of claim 1, wherein an emission wavelength of the laser element is 380 to 420 nm.

15. A method for manufacturing an optical semiconductor device comprising
a laser element,
an optical block provided with a hologram element for diffracting a laser beam that has been emitted from the laser element and reflected by an information medium,
a light-receiving portion for receiving the laser beam diffracted by the hologram element and outputting an electric signal, and
a package for receiving the laser element and the light-receiving portion,
wherein an internal space of the package is sealed by integrating the package and the optical block, and a space separation element provided in the package forms a plurality of spaces, the method comprising:
a first process of bonding the laser element to the package;
a second process of disposing the space separation element so as to seal a space receiving the laser element;
a third process of bonding the light-receiving portion to the package; and
a fourth process of integrating the optical block with the package.
